(19) United States
(12) Patent Application Publication
(10) Pub. No.: US 2006/0253235 A1
(43) Pub. Date: Nov. 9, 2006

(54) Method of wireless vehicle diagnosis

(75) Inventors: Qi Bi, Morris Plains, NJ (US); Patrick Li, Mendham, NJ (US); Mark E. Newbury, Hillsborough, NJ (US); Qinqing Zhang, Morganville, NJ (US)

Correspondence Address: WILLIAMS, MORGAN & AMERSON, 10333 RICHMOND, SUITE 1100, HOUSTON, TX, 77042, US

(73) Assignee: Lucent Technologies

(21) Appl. No.: 11/122,765

(22) Filed: May 5, 2005

(51) Int. Cl. G06F 19/00

(52) U.S. Cl. 701/33; 701/29; 340/438

(57) ABSTRACT

The present invention provides a method of wireless communication with a device. The method includes accessing diagnostic information associated with the device and providing the diagnostic information over an air interface.

### BACKGROUND OF THE INVENTION

1. Field of the Invention

This invention relates generally to communication, and, more particularly, to wireless communication.

2. Description of the Related Art

Motorized vehicles include increasingly complex interacting electrical and mechanical systems. The increasing complexity has been driven by many factors. For example, stricter environmental requirements and the desire for increased comfort and/or safety have raised the performance standards for current and future vehicles. For another example, vehicles are expected to be reliable and relatively easy to maintain for many years. However, no vehicle is perfectly reliable, and even the most reliable vehicle requires regular maintenance and may, on occasion, break down and require repair. Detecting and/or diagnosing faults in the electrical and/or mechanical systems has also become more complex as these systems have become more complex.

Advances in electronics and computer-aided design have improved vehicle diagnosis capabilities. For example, on-board diagnosis systems are available in most cars and light trucks. Mini-computers or processors may be installed in the vehicle to monitor and control the engine, the electrical system, the chassis, the body, accessory devices, and the like. If default condition occurs, the on-board diagnosis system may detect the fault and a warning signal (such as a red light) may be conveyed to the driver. More sophisticated diagnosis systems may monitor and collect information from the vehicle systems and store this information in the computer or processor. Thus, when the driver takes the vehicle to a service center, an external or off-board device may retrieve data on the computer over a wired connection and use the data to diagnose faults. A service representative may then provide a list of recommended maintenance procedures or repairs to the owner of the vehicle based on the diagnostic results.

However, the driver may not always want to, or be able to, drive the vehicle to the service center. For example, a fault in the electrical and/or mechanical systems may render the vehicle inoperable. For another example, the driver may notice that the vehicle is not operating in the desired and/or expected manner, but the driver may be far from the service center, or it may be a time of day when the service center is closed.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for wireless communication with a device. The method includes accessing diagnostic information associated with the device and providing the diagnostic information over an air interface.

In another embodiment of the present invention, a method is provided for wireless communication with a device. The method includes receiving diagnostic information associated with the device over an air interface and providing information indicative of a diagnosis based on the diagnostic information.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates an exemplary embodiment of a wireless vehicle diagnosis and information system, in accordance with the present invention; and

FIG. 3 conceptually illustrates an exemplary embodiment of a method for providing diagnostic information associated with a vehicle, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

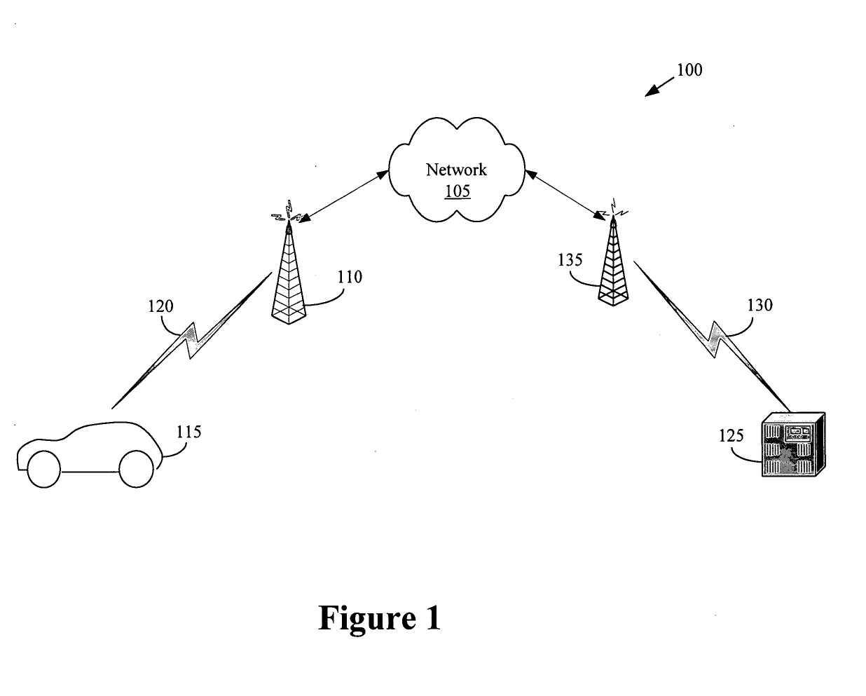

Referring now to FIG. 1, a conceptual illustration of one exemplary embodiment of a wireless communication system 100 is shown. In the illustrated embodiment, the wireless communications system 100 includes a network 105 and at least a portion of the network 105 is a wireless communication network that operates according to one or more wireless communication protocols. For example, a portion of the system 100 and the network 105 may operate according to a Universal Mobile Telecommunication System (UMTS). However, persons of ordinary skill in the art having benefit of the present disclosure should appreciate that the present invention is not limited to the system 100 that operates according to the UMTS. Other exemplary wireless communication systems, which may be used in place of or in addition to the UMTS include a Code Division Multiple Access (CDMA and/or CDMA 2000) system, a Global System for Mobile communications (GSM) system, an Evolution, Data-Only (EVDO), a Bluetooth protocol, an IEEE 802.11 protocol, and the like. Furthermore, the network 105 may also include wired networks such as a Plain Old Telephone System (POTS), a Public Switched Telephone Network (PSTN), an Ethernet, and the like.

One or more base stations 110 are communicatively coupled to the network 105. Persons of ordinary skill in the art having benefit of the present disclosure should appreciate that the base station 110 may be coupled to the network by any combination of wired and/or wireless communication links. The base station 110 provides wireless connectivity to wireless communication devices in a geographical area, or cell, proximate the base station 110. The wireless connectivity may be provided according to any desirable wireless communication protocol including, but not limited to, the protocols discussed above. Techniques for providing wireless connectivity are well known in the art and, in the interest of clarity, only those details that are relevant to the present invention will be discussed further herein.

The base station 110 provides wireless connectivity to at least one vehicle 115 over a wireless communications link, or air interface 120. In the illustrated embodiment, the vehicle 115 is an automobile. However, the present invention is not limited to automobiles. In alternative embodiments, the vehicle 115 may be a truck, a motorcycle, a boat, a plane, or any other desirable type of vehicle. Furthermore, the present invention is not limited to vehicles. For example, in some alternative embodiments, the base station 110 may provide wireless connectivity to other devices so that these devices can provide information, as discussed in detail below. For example, the base station 110 may provide wireless connectivity to appliances such as air conditioners, heaters, and the like. For another example, the base station 110 may provide wireless connectivity to other devices such as computers, personal data assistants, mobile phones, and the like. In the interest of clarity, the following discussion will be presented in the context of an embodiment that includes the vehicle 115.

As will be discussed in detail below, the vehicle 115 includes a diagnostics system that is capable of collecting diagnostic information associated with the vehicle 115. As used herein, the term “diagnostic information” refers to information that may be used to detect, diagnose, or reduce the likelihood of undesirable or unexpected operation of one or more of the electrical or mechanical systems in the vehicle. For example, the diagnostic information may include a mileage, an engine temperature, an oil pressure, a coolant level, one or more tire pressures, data provided by an on-board computer, and the like. For another example, the diagnostic information may include a signal from an impact detector, an indication that one or more air bags have deployed, and the like. The diagnostic information may be provided to the network 105 over the air interface 120.

The wireless communications system 100 also includes a service center 125 that may be communicatively coupled to the network 105. As used herein, the term “service center” refers to a computer system that may be communicatively coupled to the network 105. In various alternative embodiments, the service center 125 may be implemented in hardware, software, or any combination thereof. However, persons of ordinary skill in the art having benefit of the present disclosure should appreciate that the term “service center” may also encompass a physical location of the computer system, such as a garage. In the illustrated embodiment, the service center 125 communicates with the network via a wireless communication link 130 (or air interface) to a radio tower 135, which is communicatively coupled (by a wired and/or wireless link) to the network 105.

The service center 125 may access the diagnostic information provided by the vehicle 115. In one embodiment, the service center 125 uses the diagnostic information associated with the vehicle 115 to detect and/or diagnose faults in the electrical and/or mechanical systems associated with the vehicle 115. The service center 125 may also use the diagnostic information associated with the vehicle 115 to determine whether or not to recommend maintenance procedures for the vehicle 115. The maintenance procedure may help reduce the likelihood of undesirable or unexpected operation of the vehicle. For example, the service center 125 may use the mileage of the vehicle 115 to determine whether or not to recommend a regularly scheduled maintenance. In one embodiment, the service center 125 may provide a query requesting the diagnostic information and may provide information indicative of the diagnosis to the vehicle 115.

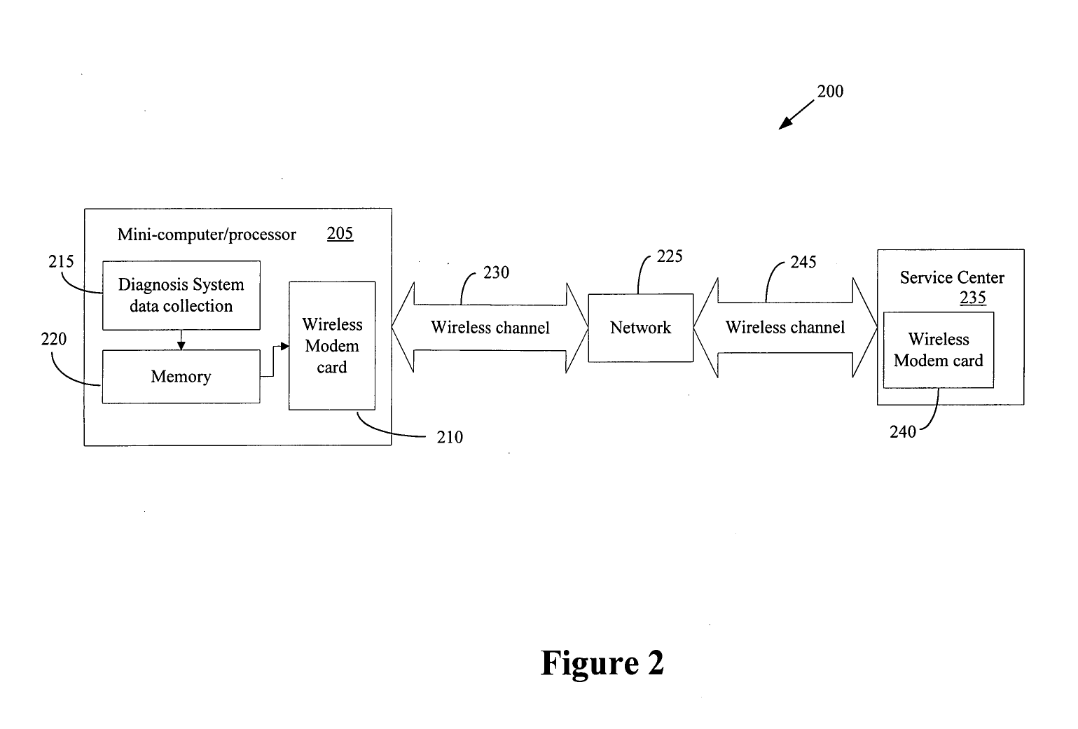

FIG. 2 conceptually illustrates an exemplary embodiment of a wireless vehicle diagnosis and information system 200. In the illustrated embodiment, the system 200 includes a mini-computer or processor 205. A modem card 210 is installed on the processor 205 to provide a communication interface between the vehicle and the wireless communication system, such as the vehicle 115 and base station 110 shown in FIG. 1. In one embodiment, the modem card 210 includes a transmitter/receiver (not shown) and the associated signaling processing units (not shown) to send/receive signals over the air. However, persons of ordinary skill in the art having benefit of the present disclosure should appreciate that any desirable hardware and/or software may be used to provide the communication interface.

A diagnosis system 215 monitors and collects diagnostic information associated with the electrical and/or mechanical systems in the vehicle, such as the engine, parts of the chassis, the body, various accessory devices, and the like. In one embodiment, the diagnostic information is stored in a memory 220. The memory 220 may be connected to the modem card 210 via an interface (such as a high-speed bus) so that the modem card 210 can retrieve the diagnostic information from the memory 220. The modem card 210 may then transmit the diagnostic information to a network 225 over a wireless channel230. In one embodiment, transmission of the diagnostic information can be scheduled to transmit the diagnostic information at night time when the wireless traffic is light so that the transmission of the diagnostic information may not interfere with regular voice and/or data traffic. Scheduling the transmission for light traffic times may help to maintain the voice and data capacity of the wireless system that includes the wireless vehicle diagnosis and information system 200, particularly during periods of heavy voice and/or data traffic.

In the illustrated embodiment, the diagnostic information is transmitted from the network 225 to the service center 235 over a wireless channel 245. The service center 235 includes a modem card 250 to provide a communication interface with the network 225. The service center 235 may diagnose and/or analyze the diagnostic information and make a recommendation of what services might be needed for the vehicle. Other information such as a request for emergency road assistance, location services, and the like may also be provided over the wireless channel 245. In one embodiment, the service center 235 maintains a database of the service records of the various vehicles that may transmit diagnostic information. Thus, the diagnosis and/or analysis may be based in part on the maintenance records. Techniques for analyzing diagnostic information associated with vehicles are well-known to persons of ordinary skill in the art and, in the interest of clarity, will not be discussed further herein.

The service center 235 may periodically send a request (or query) to each vehicle asking for the diagnostic information. For example, the service center 235 may access the database of vehicle maintenance records to determine when to send a query to a vehicle. Upon request, the vehicle may send the diagnostic information to the service center 235. The service center 235 may also provide information indicative of the diagnosis and/or analysis of the diagnostic information. In one embodiment, the service center may mail a letter or call the client to provide a service recommendation. Alternatively, the service center 235 may transmit the information indicative of the diagnosis and/or analysis to the processor 205 via the wireless channels 230, 245. The information indicative of the diagnosis and/or analysis may then be presented using a display within the vehicle.

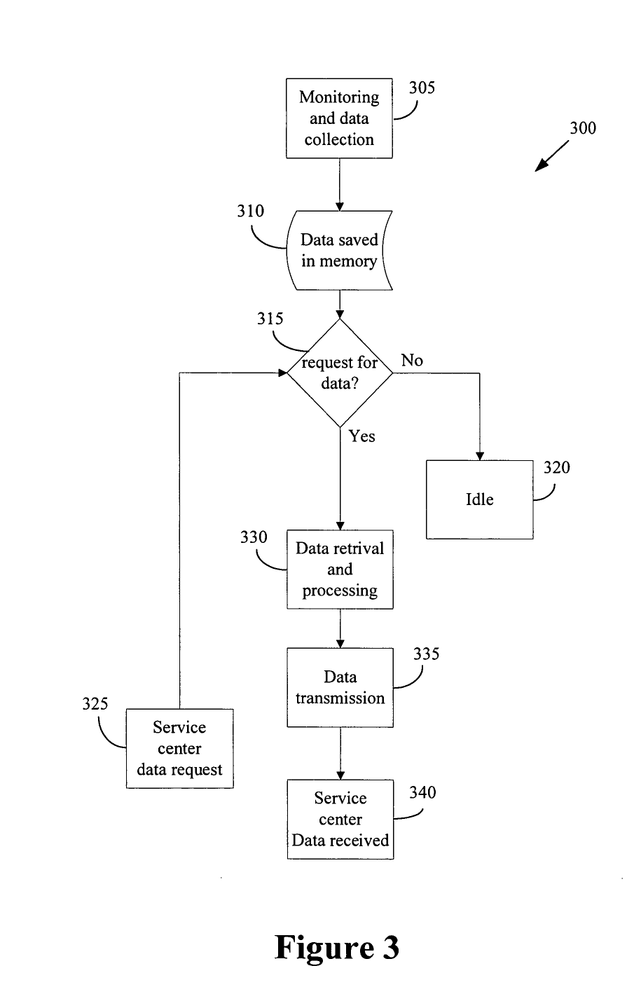

FIG. 3 conceptually illustrates an exemplary embodiment of a method 300 for providing diagnostic information associated with a vehicle. The vehicle is monitored and diagnostic information is collected (at 305) and, in one embodiment, the diagnostic information may be saved (at 310) in a memory. When the memory has not received (at 315) a request for diagnostic information from a service center, then the diagnostic system may remain idle (at 320). The service center may provide (at 325) a request for diagnostic information and when this request is received (at 315) the diagnostic information may be retrieved (at 330) from the memory. In one embodiment, retrieving (at 330) the diagnostic information may include processing (at 330) to convert the diagnostic information into a format suitable for transmission. The diagnostic information is then transmitted (at 335) over an air interface and received (at 340) by the service center.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless communication with a device, comprising:
accessing diagnostic information associated with the device; and
providing the diagnostic information over an air interface.

2. The method of claim 1, wherein accessing the diagnostic information comprises accessing the diagnostic information from a memory.

3. The method of claim 1, wherein accessing the diagnostic information comprises accessing diagnostic information collected by an on-board diagnosis system.

4. The method of claim 1, wherein providing the diagnostic information comprises providing the diagnostic information as a scheduled time.

5. The method of claim 1, comprising receiving information indicative of a diagnosis in response to providing the diagnostic information.

6. The method of claim 5, wherein receiving the information indicative of the diagnosis comprises receiving the information indicative of the diagnosis over the air interface.

7. The method of claim 1, comprising receiving a query.

8. The method of claim 7, wherein accessing the diagnostic information comprises accessing the diagnostic information in response to the query.

9. The method of claim 1, wherein the device comprises a vehicle.

10. A method of wireless communication with a device, comprising:
receiving diagnostic information associated with the device over an air interface; and
providing information indicative of a diagnosis based on the diagnostic information.

11. The method of claim 10, comprising providing a query.

12. The method of claim 11, wherein receiving the diagnostic information comprises receiving the diagnostic information in response to the query.

13. The method of claim 11, wherein providing the query comprises:
accessing a database of maintenance records associated with the device; and
providing the query based on the database of maintenance records.

14. The method of claim 10, wherein providing the information indicative of the diagnosis comprises providing a service recommendation.

15. The method of claim 10, wherein providing the information indicative of the diagnosis comprises providing the diagnosis using at least one of a letter or a telephone call.

16. The method of claim 10, wherein providing the information indicative of the diagnosis comprises providing the information indicative of the diagnosis over the air interface.

17. The method of claim 10, comprising displaying the information indicative of the diagnosis in the vehicle.
